(19) United States
(12) Patent Application Publication
(10) Pub. No.: US 2015/0365879 A1
(43) Pub. Date: Dec. 17, 2015

(54) COMMUNICATION METHOD IMPLEMENTED BY A RELAY NODE

(71) Applicant: AIRBUS DS SAS, Elancourt (FR)

(72) Inventors: Gerard Marque-Pucheu, Verneuil (FR); Laurent Pison, Jouars Ponchartrain (FR); Olivier Paterour, Guyancourt (FR)

(73) Assignee: AIRBUS DS SAS, Elancourt (FR)

(21) Appl. No.: 14/574,747

(22) Filed: Dec. 18, 2014

(30) Foreign Application Priority Data
Dec. 30, 2013 (FR) 1363698

(51) Int. Cl. H04W 40/22; H04L 12/801; H04B 7/15

(52) U.S. Cl. CPC H04W 40/22; H04B 7/15; H04L 47/18

(57) ABSTRACT

The invention relates to a data packet communication method for a telecommunications network implemented by a relay node of said telecommunications network between a base station and at least one piece of user equipment and remarkable in that it comprises a step (E1) of receiving a plurality of data packets, a step (E2) of selecting, according to at least one selection criterion, at least one data packet out of the data packets received, a step (E3) of application processing the selected data packet and a step (E4) of emitting processed data packets to the user equipment.

### TECHNICAL FIELD AND OBJECT OF THE INVENTION

This invention relates to the field of telecommunications and particularly concerns a relay node, a method and a system for communication.

### BACKGROUND

The Third Generation Partnership Project (3GPP) has defined networks known as ‘Long Term Evolution’ (LTE) in release 10 of its standard. In particular, release 10 of the 3GPP LTE standard includes support for relay nodes as described for example in the 3GPP specification TR 36.806 V9.0.0.

A relay node is an intermediate network node, generally with a low power rating, which relays packets of data between one or more mobile terminals, for example LTE user equipment and a base station, called the ‘donor eNB’ (DeNB) in the 3GPP LTE standard, which is in turn connected to the fixed land part of the LTE network.

The relay node does not have its own fixed land link connection, but is connected to the donor eNB through a wireless communication link. Such a relay node is advantageously deployed in order to extend the cell coverage of a node B, for example in areas where no connection to node B is available.

The communication link between the relay node and the donor eNB is called the connection link (or Un interface) and the link between the relay node and a mobile terminal connected to said relay node is called the access link (or Uu interface).

In order to communicate with each other, the pieces of equipment in an LTE network exchange data that are routed in packets through the network in a known manner, using the Internet Protocol (IP) routing protocol. Such an IP protocol defines the rules for routing in the network and is a level 3 protocol according to the Open Systems Interconnection (OSI) model that is well known to the person skilled in the art.

The LTE relay node is aimed at transferring IP data packets from the user equipment to the donor eNB and vice-versa.

In the case of group communication, defined in the LTE standard under the acronym GCSE (Group Communication System Enablers), between an application server for group communication linked to the LTE network and a series of pieces of user equipment connected to the relay node via the access link, each piece of user equipment comprises a group communication application which communicates with the application server through a distinct IP communication link called a tunnel. This operating mode is commonly called the unicast transmission mode.

In such a link, data packets to be sent to one piece of user equipment are transmitted seamlessly by the relay node, that is to way with no processing or analysis other relating to their IP routing address.

That is why it is necessary to create as many distinct IP tunnels as the number of pieces of user equipment participating in group communication, which uses up significant bandwidth, particularly between the relay node and the donor eNB, the more so because the bandwidth available at the relay node must be shared between the access link and the connection link of the relay node, which thus has considerable drawbacks.

### OVERALL DESCRIPTION OF THE INVENTION

This invention aims to remedy at least some of those drawbacks by proposing a communication method implemented by a relay node that allows both better use of bandwidth between the relay node and the donor eNB and also efficient processing of data packets by the relay node.

To that end, the invention relates to a data packet communication method for a telecommunications network, wherein said method, implemented by a relay node of said telecommunications network between a base station and at least one piece of user equipment, is remarkable in that it comprises:
a step when a plurality of data packets are received,
a step when at least one data packet is selected out of the data packets received on the basis of at least one selection criterion,
a step when the selected data packet is application processed, and,
a step when the processed data packet is emitted to the user equipment.

In a preferred embodiment of the method according to the invention, a plurality of data packets is selected and processed out of the received packets.

Preferably, the relay node is configured to communicate with the base station through a first radio communication link and with the user equipment through a second radio communication link, the plurality of data packets is received through the first radio communication link or the second radio communication link and processed data packets are emitted through the second radio communication link.

Also preferably, the telecommunications network is a network of the 3GPP LTE type or more recent, and the base station is a donor eNB.

In one aspect of the invention, the step of the application processing of the selected data packet comprises duplication and/or modification of the selected data packet.

If communication is shared by a group comprising a plurality of pieces of user equipment connected to the relay node, only one IP tunnel is thus required between the base station and the relay node, since the relay node can, according to the invention, select the data packets associated with group communication received from a group communication application server via the base station on the connection link in order to duplicate them and then emit them on the access link to each piece of user equipment participating in group communication.

In that case, the application server is configured to exchange group communication packets with the relay node through only one data packet communication link (i.e. only one IP tunnel).

Also in the case of group communication, the relay node can advantageously select data packets associated with said group communication, sent by one of the pieces of user equipment to, in particular, other pieces of user equipment connected to said relay node and participating in group communication, in order to transmit them to said pieces of equipment with no need to route them up to the application server. That makes it possible to avoid what is known to the person skilled in the art as tromboning through the network between the relay node and the application server, which significantly reduces the number of data packets exchanged and thus the use of bandwidth on the connection link between the relay node and the base station.

The selection of data packets on the basis of one or preferably more criteria corresponds to the filtering of the data packets so that only the data packets that meet the selection criterion are then application processed by the relay node, and the unselected data packets are simply routed to their recipient (user equipment or data donor eNB) by the relay node in a known manner.

The relay node thus advantageously retains its function of routing data packets when they do not meet any selection criterion, while allowing the application processing of data packets that meet at least one of the predefined selection criterion or criteria.

Preferably, data packets are Internet Protocol (IP) type packets and the selection criterion or criteria of IP data packets are one of a source and/or destination IP address, a source and/or destination port number, a type of protocol (to be detailed) and/or the direction of flow of the data packets (up to the donor eNB or down to the user equipment).

Advantageously, the method comprises a preliminary reception stage, preferably from an application server, of the selection criterion or criteria.

To that end, the relay node comprises a management module configured to set up and manage at least one communication link with the application server allowing the exchange of data comprising the selection criterion or criteria, so that the method comprises a step of emission by the application server through a communication link established by the management module of configuration data comprising at least one selection criterion and a step of reception by the relay node through said communication link of said configuration data comprising said selection criterion.

‘Application processing’ means that the selected data packets undergo processing of their IP transport part or their application data (level 7 of OSI model).

Such processing may consist in duplicating selected data packets or modifying selected data packets depending on the criterion used for selecting them and/or their nature.

For example, processing of their IP transport part under the control of the application may consist in modifying the IP transport part of the data packets in order to route them using a specific routing mode, such as for example unicast through the connection link Un or broadcast through the access link Uu allowing the transmission of IP data packets on the downward part of the access link (that is to say from the relay node to the pieces of user equipment).

Similarly, packet application data processing may consist in proxy type processing, known to the person skilled in the art, or by an application installed on the relay node, which modifies the packets on level 7, for example a Push-To-Talk (PTT) type application or a localization server known to the person skilled in the art.

The invention also relates to a relay node between the base station and at least one piece of user equipment for transmitting data packets in a telecommunications network, wherein said relay node comprises a routing module configured to receive and emit data packets, wherein the relay node is remarkable in that the routing module is further configured to select, according to at least one selection criterion, at least one data packet out of the data packets received and in that it comprises an application processing module configured to process the data packet selected by the routing module.

The data packet or packets received by the reception module and selected by the selection module are thus transferred by the routing module to the application processing module in order to be processed and then the data packet or packets processed in that manner are sent by the routing module to their destination.

The data packet or packets received by the reception module but not selected by the selection module are transferred directly by the routing module to their destination. More accurately, the unselected data packet or packets received from the base station are routed directly to the user equipment to which said packets are to be sent and/or the unselected data packet or packets received from the user equipment are routed directly to the base station.

Preferably, the routing module comprises a selection filter using at least one criterion for selecting at least one data packet out of the data packets received.

In one aspect of the invention, the application processing module is configured to process a selected data packet according to a plurality of processing modes corresponding to a type of application associated with said selected data packet.

In a preferred aspect of the invention, the application processing module is configured to duplicate data packets, particularly in the case of data packets corresponding to group communication.

In another preferred aspect of the invention, the application processing module is configured to modify data packets, for example in the case of data packets corresponding to an application of the Push-To-Talk (PIT) type or a localization server known to the person skilled in the art.

The selection criteria can be used advantageously to characterize the data packet so that the application processing module applies to it the processing module corresponding to the type of associated application.

Preferably, the selection criteria are configurable in the routing module.

Advantageously, the routing module is configured to receive at least one selection criterion, preferably from an application server, and to implement said received selection criterion.

The invention also relates to a telecommunications system comprising:
a relay node as presented previously,
at least one piece of user equipment configured to exchange data packets with said relay node,
a base station configured to exchange data packets with the relay node.

Preferably, the system further comprises an application server configured to exchange data packets with the relay node via the base station.

In a preferred manner, the system comprises a plurality of pieces of user equipment configured to send and receive data packets relating to group communication and the application server is configured to send data packets relating to group communication of said pieces of user equipment to the relay node in a single communication tunnel, wherein the relay node duplicates the packets received and sends them to each of the pieces of user equipment for group communication.

The invention also relates to a computer program comprising instructions for implementing the method as presented previously when the program is executed by at least one processor.

Other characteristics and advantages of the invention will appear in the description below by reference to the figures attached given as non-limitative examples, wherein identical references are given to similar objects.

### DESCRIPTION OF FIGURES

FIG. 1 is a schematic illustration of an embodiment of the system according to the invention.

FIG. 2 is a schematic illustration of an embodiment of a relay node according to the invention defined in the user plane.

FIG. 3 is a schematic illustration of a first embodiment of a relay node according to the invention defined in the control plane.

FIG. 4 is a schematic illustration of a second embodiment of a relay node according to the invention defined in the control plane.

FIG. 5 is an illustration of an embodiment of the method according to the invention.

### DETAILED DESCRIPTION OF THE INVENTION

### Description of an Embodiment of the System According to the Invention

I. System

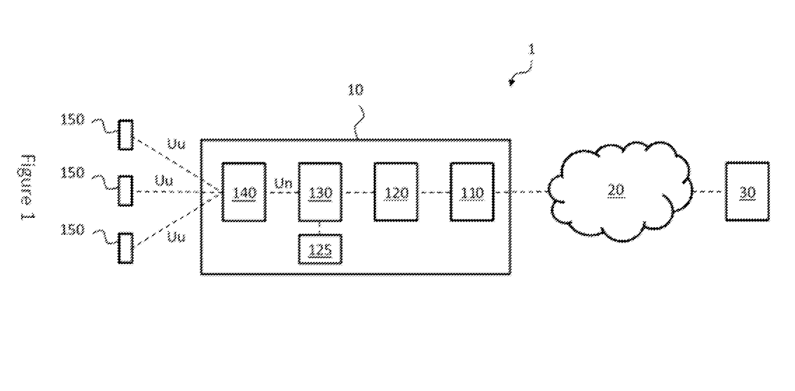

The embodiment of the system 1 according to the invention illustrated in FIG. 1 comprises a communication network 10 of the Long Term Evolution (LTE) type.

The LTE communication network 10 is connected to an application server 30 via an interconnection network 20, for example the Internet.

The application server 30 comprises one or more applications configured to receive and send IP (Internet Protocol) data packets comprising application data associated with said applications, from or to the user equipment 150 respectively via the interconnection network 20 and the communication network 10.

For example, an application installed on the application server 30 may be a group communication application known under the name Group Communication System Enabler (GCSE) in the usual vocabulary of 3GPP LTE networks.

Also by reference to FIG. 1, the application server 30 is configured to send data packets relating to group communication from a plurality of pieces of user equipment 150, to a relay node 140 to which said pieces of user equipment 150 are connected in a single IP communication tunnel.

The application server 30 is adapted to send configuration data comprising at least one criterion for selecting data packets to a relay node 140 of the communication network 10 described below.

1) LTE Communication Network 10

In order to allow the application server 30 to exchange data packets with pieces of user equipment 150 via the interconnection network 20, the LTE communication network 10 comprises, also by reference to FIG. 1, a Packet Data Network Gateway (or PGW) 110, a Serving Gateway (SGW) 120, a Mobility Management Entity (MME) 125, a base station 130, a relay node 140 and a plurality of pieces of user equipment 150.

The packet data network gateway 110 is an access point that enables the application server 30 to communicate with the communication network 10 via the Internet interconnection network 20.

The serving gateway 120 is placed between the packet data network gateway 110 and the donor eNB 130 and is configured to route, that is direct, data packets between the data packet network gateway 110 and the base station 130.

The mobility management entity MME 125 is configured to establish and modify the LTE bearers between the packet data network gateway PGW 110, the serving gateway SGW 120, the base station 130 and the relay node 140 in order to carry application data packets.

The base station 130 of an LTE network is called the ‘node B’. Such a node B acts as the connection between the serving gateway 120 and the radio communication interface. The node B is called a ‘donor’ because it is connected to a relay node 140.

The relay node 140 is an intermediate network node, generally with a low power rating, which relays data packets between the pieces of user equipment 150 and the donor eNB 130.

The relay node 140 does not have a fixed land link connection but is connected through a wireless communication link to the donor eNB 130.

One or more relay nodes 140 may be deployed in order to extend the cell coverage of a node B 130, for example in areas where no connection to the donor eNB 130 is available.

The wireless communication link between the relay node 140 and the donor eNB 130 is called the connection link (or interface) and the communication link between the relay node 140 and a piece of user equipment 150 connected to said relay node 140 is called the access link (or interface). The connection link may be an interface of the Un type and the access link may be an interface of the Uu type as illustrated in FIG. 1. As an alternative, the connection link may be an interface of the Uu type and the access link may be an interface of the PC9 type as defined in the specification 3GPP TS 23.703 V1.0.0.

The pieces of user equipment 150 are configured to exchange application data encapsulated in data packets with the application server 30 through the communication network 10 via the relay node 140.

In order to be directed, in a manner known to the person skilled in the art, up to the application server 30, such application data are encapsulated by the relay node 140 in IP data packets.

Only one packet data network gateway 110, only one serving gateway 120, only one donor eNB 130 and only one relay node 140 have been represented in FIG. 1, but it goes without saying that the communication network 10 may comprise a plurality of packet data network gateways 110, serving gateways 120, donor eNBs 130 and relay nodes 140.

Besides, other pieces of equipment of the LTE communication network 10, well known to the person skilled in the art but which have not been represented in FIG. 1 for the sake of clarity, may exist between a donor eNB 140 and the interconnection network 20.

Lastly, it also goes without saying that only one piece of user equipment 150 can be connected to the relay node 140 according to the invention.

2) Relay Node 140

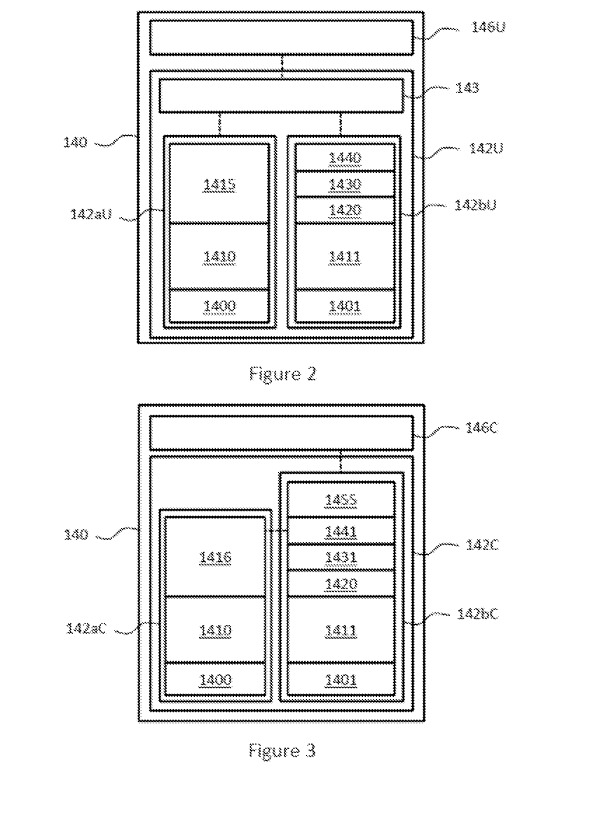

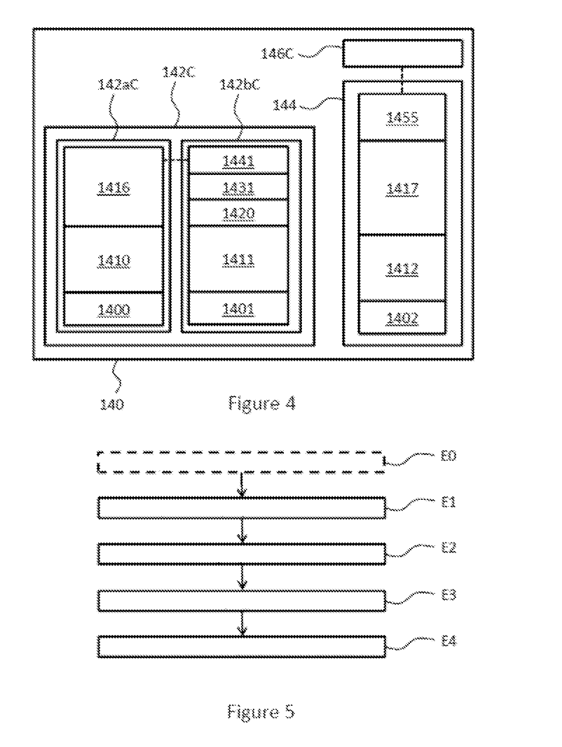

One embodiment of the relay node 140 according to the invention is illustrated in FIG. 2 in respect of its user plane and in FIGS. 3 and 4 in respect of its control plane.

The user plane defines, in a manner known to the person skilled in the art, the protocols used for exchanging packets comprising application data between a piece of user equipment and an application server or between two pieces of user equipment. FIG. 2 describes these protocols on the basis of the 3GPP model.

The control plan defines, in a manner known to the person skilled in the art, the signaling protocols used for exchanging data packets.

The relay node according to the invention comprises a routing module 142U (in the user plane) and 142C (in the control plane) and an application processing module 146U (in the user plane) and 146C (in the control plane).

a) Routing Module 142U/142C

The relay node 140 comprises a routing module 142U/142C configured in a known manner to communicate, firstly with pieces of user equipment 150 via a first communication sub-module 142aU/142aC via the access link Uu and secondly with the donor eNB 130 via a second communication sub-module 142bU/142bC via the connection link Un.

In other words, the routing module 142U/142C is configured to receive and emit data packets from or to the pieces of user equipment 150 via the first communication sub-module 142aU/142aC and to receive and emit data packets from or to the donor eNB 130 via the second communication sub-module 142bU/142bC.

In the user plane, as shown in FIG. 2, the first communication sub-module 142aU comprises the following in a known manner:
a physical stratum 1400 also called level 1 stratum in the specification 3GPP TS 36.201,
a level 2 stratum 1410 comprising a Medium Access Protocol (MAC) sub-stratum in accordance with the specification 3GPP TS 36.321, a Radio Link Control (RLC) sub-stratum in accordance with the specification 3GPP TS 36.322 and a Packet Data Convergence Protocol (PDCP) sub-stratum in accordance with the specification 3GPP TS 36.323, and
a void level 3 stratum 1415 for the user plane because it is IP directly at the output of the PDCP.

Also in the user plane and by reference to FIG. 2, the second communication sub-module 142bU comprises the following in a known manner:
a level 1 stratum 1401 similar to the physical stratum 1400 of the first communication sub-module 142aU,
a level 2 stratum 1411 similar to the level 2 stratum 1400 of the first communication sub-module 142aU, and
a level 3 stratum comprising a first sub-stratum 1420 with the IP protocol (Internet Protocol—IETF RFC 791 (Ipv4) or IETF RFC 2460 (Ipv6)), a second sub-stratum 1430 with the UDP protocol (defined by the specification IETF RFC 768) and a third sub-stratum 1440 that is GTP-U—GPRS (General Packet Radio System) Tunneling Protocol—User Plane according to the specification 3GPP TS 29.281.

According to the invention, the routing module 142U comprises a filter 143 configured for selecting, on the basis of at least one selection criterion, one or more data packets received by the first communication sub-module 142aU or by the second communication module 142bU.

Such a filter 143 is configurable and makes it possible to select several IP data packets received from a piece of user equipment 150 by the first communication sub-module 142aU or received from the donor eNB 130 by the second communication sub-module 142bU.

The filter 143 is configured by defining one or more selection criteria such as, for example, a source and/or destination IP, a source and/or destination port number, a type of protocol (TCP, UDP, RTP etc., known to the person skilled in the art), the packet exchange direction (up to the donor eNB or down to the user equipment) etc.

For example, the applications (servers and clients) use an IP address or a series of IP addresses. These applications use one or more protocols. Depending on the protocol or protocols used by these applications, a port or a series of ports may be used as selection criteria.

Also, for example, for group communication, the IP address and the ports from which data packets from a Push-To-Talk (PTT) type server are transmitted may be known so as to intercept them both for control in the control plane, with for example, SIP, XMPP or other protocols known to the person skilled in the art, or media in the user plane with, for example, RTP, RTSP or other protocols known to the person skilled in the art.

On the other hand, data packets received from a piece of user equipment 150 that do not meet the filtering criterion or criteria are transmitted directly to the second communication sub-module 142bU in order to be sent to the donor eNB 130.

Similarly, data packets received from the donor eNB 130 that do not meet the filtering criterion or criteria are transmitted directly to the first communication sub-module 142bU in order to be sent to one or more pieces of user equipment 150 for which said packets are intended.

The data packets that fulfill one or more filtering criteria are directed to the application processing module 146U described below.

The filter 143 can for example take the form of a Traffic Flow Template (TFT) filter known to the person skilled in the art.

In order to configure the filter 143, the routing module 142U/142C is configured to receive the criterion or criteria for the selection (i.e. filtering) of the data packets, preferably from the application server 30.

To that end, by reference to FIGS. 3 and 4, the relay node 140 comprises a management module 1455 configured to establish and manage signaling in the control plane, particularly so as to receive the criterion or criteria for selecting data packets.

Such a management module 1455 takes the form in this example of a Non-Access Stratum (or NAS) known to the person skilled in the art.

In a first embodiment illustrated in FIG. 3, the management module is an NAS sub-stratum 1455 of the second communication module 142bC in the control plane.

In that control plane, the first communication sub-module 142aC establishes the user plane that makes it possible to receive and/or send control data packets particularly comprising the selection criterion or criteria by using a level 1 stratum 1400 similar to the level 1 stratum 1400 of the first communication sub-module 142aU described above by reference to FIG. 2, a level 2 stratum 1410 similar to the level 2 stratum 1410 of the first communication sub-module 142aU described above by reference to FIG. 2 and a level 3 stratum 1416 RRC (Radio Resource Control) in accordance with the specification 3GGP TS 36.331.

Similarly, in that control plane, the second communication sub-module 142bC receives and/or sends control data packets by using a level 1 stratum 1401 similar to the level 1 stratum 1400 of the first communication sub-module 142aC described above by reference to FIG. 3, a level 2 stratum 1411 similar to the level 2 stratum 1410 of the first communication sub-module 142aC described above by reference to FIG. 3 and a level 3 stratum comprising:
a first sub-stratum 1420 similar to the first level sub-stratum 1420 of the second communication sub-module 142bU described above by reference to FIG. 2,
a second sub-stratum 1431 of the SCTP (Stream Control Transmission Protocol defined in specification IETF RFC 4960 used as the transport stratum of a signaling link called S1-Mobility Management Entity) protocol,
a third sub-stratum 1441 with the S1AP (S1 Application Protocol defined in the specification 3GPP TS 36.413, which provides signaling between the E-UTRAN radio access interface and the evolved packet core) protocol, and,
the NAS sub-stratum 1455.

The NAS (Non Access Stratum) protocol sub-stratum complies with the specification GPP TS 24.301 and defines the procedures used by the protocols for managing mobility and sessions between a piece of user equipment 150 and the mobility management entity MME 125.

In a second embodiment illustrated in FIG. 4, the relay node 140 comprises a first communication sub-module 142aC and a second communication sub-module 142bC identical to those of the embodiment described above by reference to FIG. 3 with the exception of the NAS sub-stratum 1455 that is no longer located in the second communication sub-module 142bC but in a communication module 144, external to the routing module 142C, where the processing module 146C communicates with the NAS sub-stratum 1455.

That communication module 144 comprises, also in the control plane:
a level 1 stratum 1402 similar to the level 1 stratum 1400 of the first communication sub-module 142aC described above by reference to FIG. 3,
a level 2 stratum 1412 similar to the level 2 stratum 1410 of the first communication sub-module 142aC described above by reference to FIG. 3,
a level 3 stratum 1417 similar to the level 3 stratum 1416 of the first communication sub-module 142aC described above by reference to FIG. 3, and
a NAS sub-stratum 1455 similar to the NAS sub-stratum 1455 of the second communication sub-module 142bC described above by reference to FIG. 3.

In other words, in this control plane, this communication module 144 comprises strata similar to those of the first communication sub-module 142aC of the routing module 142C and further comprises the NAS management sub-stratum 1455.

The level 1 stratum 1402, the level 2 stratum 1412 and the level 3 stratum 1417 of the communication module 144 are used in a known manner to initially connect the relay node 140 to a node B.

The NAS sub-stratum 1455 is thus advantageously added to that second existing routing module, which is thus reused for establishing signaling to allow the relay node 140 to receive the selection criteria from the application server 30 in the user plane.

b) Application Processing Module 146U/146C

According to the invention, by reference to FIG. 2, the relay node 140 comprises an application processing module 146U configured to process application data packets selected by the filter 143 of the routing module 142.

That application processing module 146U is configured to process the data packets directed by the filter 143 according to predetermined and configurable rules associated with the application to which the application data of the IP data packets correspond.

In particular, the application processing module 146U may be configured to duplicate an IP data packet or to modify it.

For example, processing of their IP transport part under the control of the application may consist in modifying the IP transport part of the data packets in order to route them using a specific routing mode, such as for example unicast through the connection link Un or broadcast through the access link Uu allowing the transmission of IP data packets on the downward part of the access link (that is to say from the relay node to the pieces of user equipment).

Similarly, packet application data processing may consist in proxy type processing, known to the person skilled in the art, or by an application installed on the relay node, which modifies the packets on level 7, for example a Push-To-Talk (PTT) type application or a localization server known to the person skilled in the art.

The application processing module 146U and/or 146C is further configured to request the configuration of the filter from the application server of the filter 143.

In this control plane, the application processing module 146C is configured to establish the path between the application processing module of the user plane 146U and the application server 30 and to start and control the filter 143 and the application processing module 146U in the user plane.

II. Implementation

One mode of implementation of the method according to the invention will now be illustrated by reference to FIG. 5, using group communication managed by the application server 30 and involving the user equipment 150 as an example.

The NAS sub-stratum 1455 establishes, via the MME mobility management entity 125, the signaling required for the relay node 140 to receive, in a preliminary step E0, the selection criterion or criteria from the application server 30 so that the relay node 140 implements them in the filter 143.

### a) EXAMPLE 1

### Sending of Data Packets by the Application Server 30

In this example of group communication, the filter 143 is configured to identify the data packets relating to said group communication, for example on the basis of a criterion corresponding to the IP address of the application server 30 that they contain or a port number.

Similarly, the application processing module 146U is configured to duplicate the data packets selected by the filter 143 and to add the address of each piece of user equipment 150 that is the recipient of said packets.

In this example, IP data packets relating to group communication are first sent by the application server 30 to the relay node 140 in a single communication tunnel, for example of the GTP-u type that is well known to the person skilled in the art.

To that end, these application data packets go through the interconnection network 20, the PGW packet data network gateway 110, the SGW serving gateway 120, the donor eNB 130 and are received in a step E19 by the second communication sub-module 142bU of the routing module 142U of the relay node 140.

The second communication sub-module 142bU transmits them to the filter 143, which detects that these data packets relate to group communication between the application server 30 and the pieces of user equipment 150, because they contain the IP address of the application server 30, and thus selects them in a step E2 and then transmits them to the application processing module 146U.

In a step E3, the application processing module 146U then processes the packets selected by the filter 143 by duplicating them and by adding the address of each piece of user equipment 150 for which said packets are intended.

The processing module 146 then transmits them to the first communication sub-module 142aU, which sends them in a step E4 to each piece of user equipment 150.

### b) EXAMPLE 2

### Sending of Data Packets by a Piece of User Equipment 150

In this example of group communication, the filter 143 is configured to identify the data packets relating to said group communication, for example on the basis of a criterion corresponding to the IP address of the user equipment 150 that emits said packets contained in them.

Similarly, the application processing module 146U is configured to add the address of the pieces of user equipment 150 for which said packets are intended.

In this example, IP data packets relating to group communication are first sent by a piece of user equipment 150 to the relay node 140.

These packets are received in a step E1 by the first communication sub-module 142aU of the routing module 142U of the relay node 140.

The first communication sub-module 142bU transmits them to the filter 143, which detects that these data packets relate to group communication between the pieces of user equipment 150 and the application server 30, because they contain the IP destination address of the application server 30, and thus selects them in a step E2 before transmitting them to the application processing module 146U.

In a step E3, the application processing module 146U then processes the packets selected by the filter 143 by adding the address of the pieces of user equipment 150 for which said packets are intended in respect of the data packets that are to be retransmitted by the first communication sub-module 142aU of the routing module 142U.

The processing module 146U then transmits them to the first communication sub-module 142aU, which sends them in a step E4 to the recipient pieces of user equipment 150 or the second communication sub-module 142bU which sends them in a step E4 to the application server that manages group communication, for example for it to transmit them to other pieces of user equipment (not shown) connected to the interconnection network 20.

The invention thus advantageously allows a relay node of an LTE network to analyze the application data packets in order to process them when they meet one or more selection criteria.

With the method and the relay node according to the invention, particularly in the case of group communication, the number of packets sent by the application server managing said group communication is thus advantageously divided by the number of pieces of user equipment for which said packets are intended, by comparison with group communication through a relay node of the prior art. That makes it possible to considerably reduce the use of resources in the LTE communication network, particularly between the relay node and the donor eNB.

The method and the relay node according to the invention also make it possible to ensure that data packets sent by a piece of user equipment connected to the relay node and intended for other pieces of user equipment connected to said relay node are not sent by the relay node to the application server (tromboning) before they come back to the node for transmission to the recipient pieces of user equipment, which also considerably reducing the use of resources in the LTE communication network, particularly between the relay node and the donor eNB.

1-10. (canceled)

11. A method of packet data communication in a telecommunications network, said method implemented by a relay node of said telecommunication network between a base station and at least one user equipment, comprising:
(E1) receiving a plurality of data packets,
(E2) selecting, according to at least one selection criterion, at least one packet of data among the received data packets,
(E3) application processing of the selected data packet, and
(E4) transmitting the processed data packet to the user equipment.

12. The method according to claim 11, wherein the relay node is configured to communicate with the base station on a first radio communication link and the user equipment on a second radio communication link, wherein the plurality of data packets is received on the first radio communication link or on the second radio communication link and transmitting processed data packets is performed on the second radio communication link.

13. The method according to claim 11, wherein the data packets are Internet Protocol (IP) type data packets, wherein the selection criterion comprises one of a source IP address, a destination IP address, a source port number, a destination port number, a protocol type, a nature of the issuer and the packet recipient.

14. The method according to claim 11, wherein step (E3) includes a step of duplicating said packet.

15. The method according to claim 11, wherein step (E3) includes a step of modifying said packet.

16. The method according to claim 11, further comprising a preliminary step (E0) of receiving the selection criterion at a server application.

17. A relay node between a base station and at least one user equipment for the communication of data packets in a telecommunications network, said relay node comprising:
a routing module configured to receive and to transmit data packets, wherein the routing module is further configured to select, according to at least one selection criterion, at least one data packet from the received data packets; and
wherein the routing module comprises an application processing module configured to process the selected data packet by the routing module.

18. The relay node according to claim 17, wherein the application processing module is configured to process a data packet selected according to a plurality of processing modes corresponding to a type of application associated with said packet selected data.

19. A telecommunication system, comprising:
a relay node,
at least one user equipment configured to exchange data packets with said relay node; and
a base station configured to exchange data packets with the relay node;
wherein the relay node comprises:
a routing module configured to receive and to transmit data packets,
wherein the routing module is further configured to select, according to at least one selection criterion, at least one data packet from the received data packets; and
wherein the routing module comprises an application processing module configured to process the selected data packet by the routing module.
